(19) United States
(12) Patent Application Publication
(10) Pub. No.: US 2016/0073149 A1
(43) Pub. Date: Mar. 10, 2016

(54) METHOD AND APPARATUS FOR IMPROVED NETWORK RECORDING

(71) Applicant: TELEFONAKTIEBOLAGET L M ERICSSON (PUBL), Stockholm (SE)

(72) Inventors: Chao FENG, Shanghai (CN); Lifeng LIANG, Shanghai (CN); Jianxiang ZHOU, Shanghai (CN)

(73) Assignee: TELEFONAKTIEBOLAGET L M ERICSSON (PUBL), Stockholm (SE)

(21) Appl. No.: 14/784,499

(22) PCT Filed: Apr. 25, 2013
(86) PCT No.: PCT/CN2013/074712

§ 371 Date: Oct. 14, 2015

(51) Int. Cl. H04N 21/274; H04N 21/234; H04N 21/231

(52) U.S. Cl. CPC H04N 21/274; H04N 21/231; H04N 21/234

(57) ABSTRACT

There is provided a method of recording a program in a server. The method comprises receiving a record instruction to record a particular program. The method further comprises accessing a plurality of time shift slice files associated with the particular program, and combining the slice files into a recorded program file.

### TECHNICAL FIELD

The present application relates to a method of recording a program in a server, a server, and a computer-readable medium.

### BACKGROUND

A content delivery network (CDN) is typically a large distributed system of servers deployed in multiple data centers across the Internet. The goal of a CDN is to serve content to end-users with high availability and high performance. CDNs were initially used in the internet for efficient distribution of web services.

CDNs are now widely used by IPTV operators to provide streaming services to user devices. The CDN improves response time, Quality of Service management and network load balancing. A CDN works by redirecting a request from end user equipment for some content to edge servers near to user. The edge servers retrieve the requested content either from a local cache or a center node within the CDN and deliver the content to the end user equipment.

IPTV delivered over a CDN may provide video-on-demand (VoD), linear television (like broadcast television), time shift (pause and rewind live tv) and recording (network personal video recording (nPVR)). These services are provided to end-user equipment or terminals connected to the IPTV platform. In the case of nPVR, this differs from a standard PVR in that with nPVR recorded content is not stored locally but is stored within the CDN.

Program recording as provided by the CDN gives basic PVR functionality to the end-user equipment. Because the content is stored in the CDN, and not locally in the end-user equipment, this type of PVR is known as a network-PVR. Using network PVR an end user can identify programs to record such that these will be made available for watching at a later time.

To record a program in a network PVR, the edge server receives a program stream carrying the program and from this it creates a recorded program file. This is a slightly complex procedure. The CMS sends a record instruction to the center node of the CDN. The center node distributes the record task file to the whole CDN or a subset of the servers in the CDN. At the scheduled time, the edge server will begin the recording of the appropriate input live stream. After the recording is finished, the recorded program file is uploaded to the center node. Then the center node distributes the recorded program file in the same way that VOD content is distributed within the CDN network. Before distribution, either the recording node or the CDN adds an index and trick play file index to the recorded program content in the recorded program file.

Distributed file storage is widely used in CDN systems, and as such requested program content may not be contained in the server near to the end user that requested it. The user request can be redirected to another server that does have the requested content.

MPEG video is referenced herein. The ISO/IEC 13818 International Standard addresses the combining of one or more elementary streams of video and audio, as well as other data, into single or multiple streams which are suitable for storage or transmission. Systems coding follows the syntactical and semantic rules imposed by the standard and provides information to enable synchronized decoding of decoder buffers over a wide range of retrieval or receipt conditions.

OIPF Services and Functions for Release 2 ([V1.0]-[2008-10-20]) is a standard document that applies to both the Managed Network and the Open Internet models. The Open IPTV Forum is targeting IPTV business models that will enable retail consumer electronics (CE) devices with IPTV Terminal Function (ITF) capabilities. Users should be able to use both operator-provided as well as user-purchased CE ITF devices to access these IPTV services and functions. This document describes time shift as allowing a user to halt a scheduled content service and continue watching the program later, by providing buffering for pause, rewind and resume.

### SUMMARY

In prior art solutions, time shift recording and program recording are isolated procedures, meaning that effectively the same content will be recorded twice. After the recorded program file is ready and uploaded to the center node, the center node will ingest the recorded program file as if it were a VoD file, and then the content will be sent back out to the edge servers. Not only is this an inefficient use of resources while the program recording is generated, but the subsequent upload and redistribution causes an extended delay before the recorded file is available for playback, as this cannot be done until the ingestion is completed.

A method and apparatus for improved network recording is described herein. This combines the program recording with time shift recording. Program recording takes as its input not a copy of the program stream but the time shift slice files generated to provide time shift functionality. The relevant time shift slice files are combined to generate the recorded program file. This provides a more efficient use of network resources and processing resources within the edge server doing the recording. Further, the recorded program file may be made available for playback sooner than in prior art systems.

There is provided a method of recording a program in a server. The method comprises receiving a record instruction to record a particular program. The method further comprises accessing a plurality of time shift slice files associated with the particular program, and combining the slice files into a recorded program file.

By using the time shift slice files as the source for recorded programming the content already received at the server can be re-used to create the recorded program file. This means that a media server can receive one stream and use this both for time shift and additionally for creating the recorded program file. The received stream may also be relayed as a live stream via a streaming module.

The method may further comprise using the timestamps of slice files to determine which are associated with the particular program. The method may further comprise receiving a video stream and creating a plurality of time shift slices of the video stream. The particular program is sent via the video stream.

The method may further comprise uploading the recorded program file to a center node. The method may further comprise receiving a playback instruction from a terminal; and streaming the recorded program to the terminal in response to the playback instruction.

The server may receive a video stream which it: outputs as a live stream; uses to provide a time shift service; and records for later streaming. The server may comprise a network PVR.

There is further provided a server arranged to record a program, the server comprising an input, a memory and a processor. The input is arranged to receive a record instruction to record a particular program. The memory is arranged to store a plurality of time shift slice files associated with the particular program. The processor is arranged to combine the slice files into a recorded program file.

By using the time shift slice files as the source for recorded programming the content already received at the server can be re-used to create the recorded program file. This means that a media server can receive one stream and use this both for time shift and additionally for creating the recorded program file. The received stream may also be relayed as a live stream via a streaming module.

The processor may be further arranged to use the timestamps of slice files to determine which are associated with the particular program. The processor may be further arranged to receiving a video stream and create a plurality of time shift slices of the video stream. The particular program is sent via the video stream.

The server may further comprise an output for sending the recorded program file to a center node. The input may be further arranged to receive a playback instruction from a terminal; and in response thereto the server streams the recorded program to the terminal via an output.

The server may be arranged to receive a video stream, which it: outputs as a live stream; uses to provide a time shift service; and records for later streaming. The server may comprise at least one of an edge server and a network PVR.

There is further provided a computer-readable medium, carrying instructions, which, when executed by computer logic, causes said computer logic to carry out any of the methods defined herein.

There is further provided a computer-readable storage medium, storing instructions, which, when executed by computer logic, causes said computer logic to carry out any of the methods defined herein. The computer program product may be in the form of a non-volatile memory or volatile memory, e.g. an EEPROM (Electrically Erasable Programmable Read-only Memory), a flash memory, a disk drive or a RAM (Random-access memory).

### BRIEF DESCRIPTION OF THE DRAWINGS

A method and apparatus for improved network recording will now be described, by way of example only, with reference to the accompanying drawings, in which:

FIG. 1 illustrates a Content Delivery Network;

FIG. 2 illustrates a signalling diagram of a prior art content delivery network;

FIG. 3 illustrates a signalling diagram of the improved program recording method described herein;

FIG. 4 illustrates the basic method of improved programme recording described herein;

FIG. 5 illustrates an alternative method of programme recording as described herein; and

FIG. 6 illustrates an apparatus for performing the methods described herein.

### DETAILED DESCRIPTION

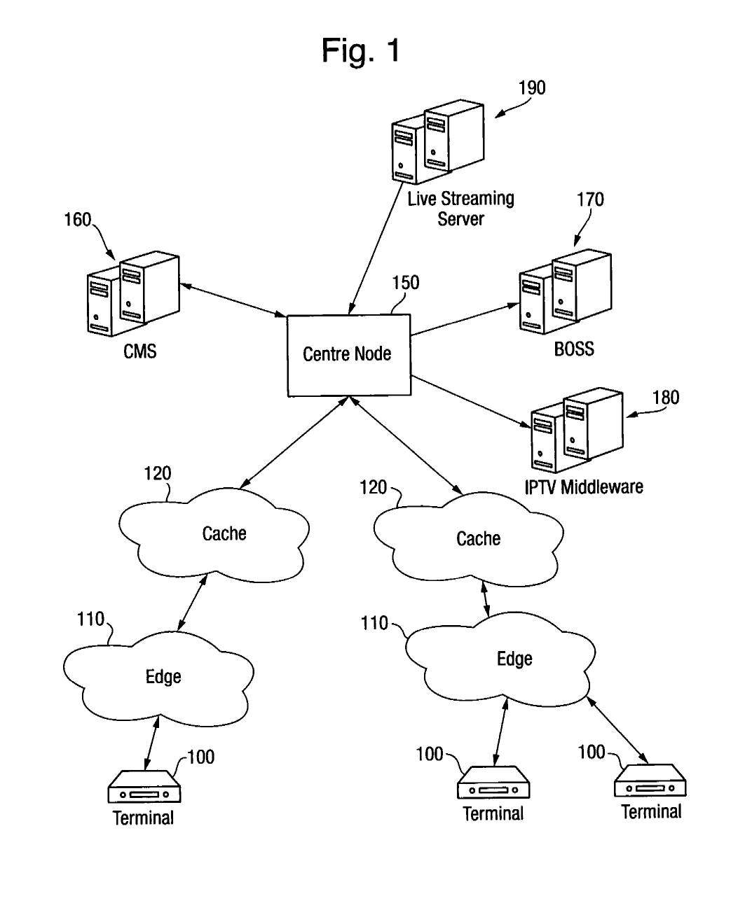

FIG. 1 illustrates a Content Delivery Network (CDN). Each terminal 100 connects to an edge server 110. Each edge server has a cache 120 associated with it. The cache 120 keeps a local copy of the content determined to be most likely requested by terminals 100 it serves. Each edge server 110 and cache 120 is connected to the center node 150. The center node 150 is the central hub of the CDN and it controls the access to and distribution of content throughout the system.

The center node 150 is connected to the content management system 160, the B/OSS 170, the IPTV Middleware server 180, and the live streaming server 190. The content management system (CMS) 160 allows publishing, editing and modifying of content as well as maintenance from a central interface. The Business and Operations Support Service (B/OSS) 170 primarily provides fault finding and billing services to the network. The IPTV Middleware server 180 controls provisions functionality and services to the terminals 100. The live streaming server 190 sends live streams similar to broadcast television into the CDN.

In operation, a request from a terminal 100 for a particular piece of content is redirected to an edge server 110 near to the user. The edge server 110 retrieves the requested content either from a local cache 120 or via the center node 150. The edge server 110 then delivers the particular requested content to the terminal 100.

The edge servers 110 receive the provisioning requests from the center node, they locally store the media content, and also provide real time streaming directly to terminals in response to user requests. A CDN allows a service provider or network operator to control the route by which content is delivered to a user terminal 100. This allows for more efficient distribution because popular content can be cached at the edge of the network. This also allows service quality to be controlled, in contrast to an over-the-top provider which relies on the internet to deliver content to users, and are thus at the mercy of the available bandwidth between their servers and the user.

Time shift requires the temporary recording of a program stream for certain period of time. This allows an end user to pause or rewind a live program, to watch with a short time delay, and to then fast forward until they catch-up with the live stream. The time shift time duration is limited, and always begins from a predetermined time period back from current time. The duration is configured by the operator.

Within a CDN, time shift recording is supported by the whole network such that each edge server will generate time shift recording files for the channels that are time shift enabled. Generally, the time shift recording files are a series of slice files, whereby each slice file stores live program content for several seconds. The time shift period perpetually scrolls forward. Such implementation makes it easy to control the total time shift duration and play back.

When a media server does time shift recording, it will generate many sequential slice files corresponding to the live input. The slice files all have timestamps, and so the system knows when they were created. Generally, the slice files are indexed. Because the time shift period is fixed and rolling, the index is only requires a limited range and will be cycled when it reaches its maximum value.

According to the improved recording process described herein, the edge server checks the recording tasks ingested by center server. When it finds a recording task that needs to be executed, it checks the slice file whose creation time matches the recording start time, then starts to copy the content of the slice file to create a program recording file. From this point, it searches the slice files whose creation time is before the recording stop time but after the recoding start time, and combines them to create the recorded program file. Once the recoding stop time is reached the recorded program file is completed by the addition of an index and a trick index both of which generated locally by the edge server. Thus, when the recorded program file is ingested to the edge server, all resources can be retrieved locally, with no additional consumption of bandwidth within the CDN.

The recording task is initiated by CMS 160 based on the operator's schedule plan. But center node 150 can define the distribution strategy and recording strategy. That is, some servers are assigned to do recording task based on the rules that it serves certain range of IP addresses. This can help ensure that the recording serves are nearby the terminals that require the recording. In this way the recorded program file can be made available to the terminal once recording and local ingestion is completed within the edge server, without any transfer of the file via the center node 150.

The method simplifies the procedure of recording, saving bandwidth within the network. Further, the end user can watch the program very soon after it has finished broadcasting.

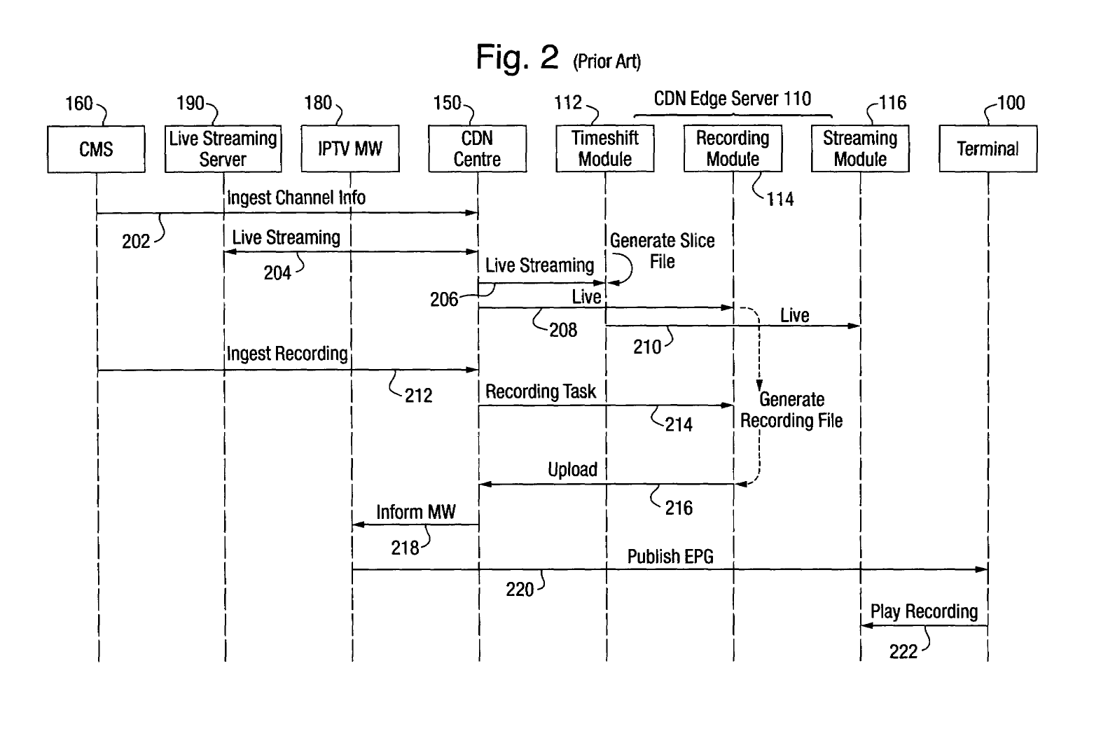

FIG. 2 illustrates a signalling diagram of a prior content delivery network. The nodes of the signalling diagram correspond to the nodes of the content delivery network illustrated in FIG. 1. At 202 centre node 150 ingests channel info from the content management system 160. At 204 the centre node 150 receives live streaming from the live streaming server 190. The centre node 150 delivers the live streaming to the edge server 110. However, the edge server 110 comprises three modules: time shift module 112; recording module 114 and streaming module 116. In the system illustrated, centre node 150 sends two copies of livestream as 206 and 208. Livestream 206 is received by both time shift module 112 and streaming module 116, this is illustrated in FIG. 1 as the livestream being relayed 210 from time shift module 112 to streaming module 116. Live stream 208 is received by the recording module 114. Upon receiving livestream 206, time shift module 112 generates slice files in order to provide time shift functionality to any connected terminals 100. Streaming module 116 receives the same livestream and this may be delivered as a livestream directly to a terminal 100; such delivery is not illustrated in FIG. 2. Recording module 114 does nothing with its received livestream 208 until a recording task is received.

At 212 the centre node ingests a recording instruction from content management system 160. Such a recording instruction may originate in the terminal 100 but such signalling is not illustrated herein. The centre node 150 sends the recording task to the recording module 114 in message 214. At the appropriate time for recording, the recording module 114 generates a recording file from the livestream 208. When the recording is completed the recording module 114 uploads 216 the recorded programme file to centre node 150. At 218 the centre node 150 informs the IPTV middle layer 180 that the recording has been received and at 220 the IPTV middle layer 180 publishes the available recording in the electronic programme guide of the terminal 100. At 222 terminal 100 requests playback of the recorded programme file from streaming module 116. The subsequent delivery of the recorded programme file to terminal 100 is not shown in FIG. 2.

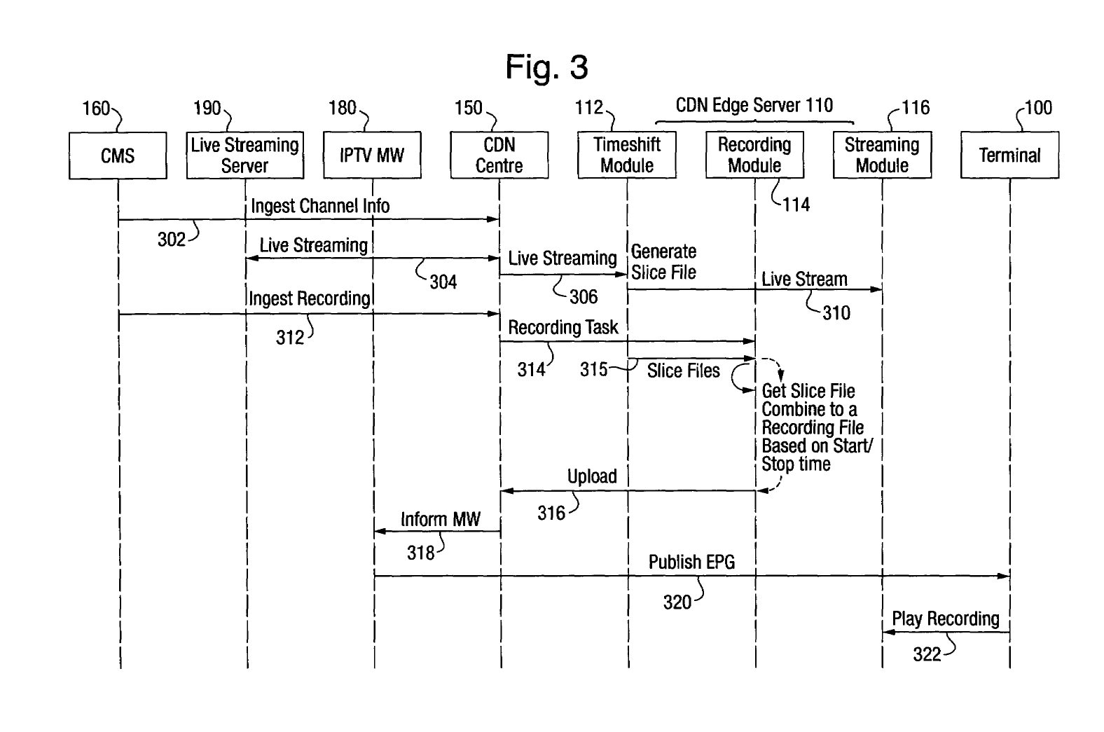

FIG. 3 illustrates a signalling diagram of the improved program recording method described herein. For brevity and clarity only the difference over the prior art system of FIG. 2 will be described here. Here, centre node 150 delivers a single livestream 306 to the edge server 110; this is shared between the time shift module 112 and the streaming module 116. As illustrated here, the time shift module 112 receives livestream 306 from centre node 150 and then relays the livestream via 310 to streaming module 116. When the recording module 114 receives a recording task 314, the recording module 114 retrieves the slice files 315 from time shift module 112. The recording module 114 combines the slice files to generate the recorded programme file based upon the start/stop time of the desired recording. The recorded programme file may be uploaded 316 to the CDN centre node 150 as done in FIG. 2.

Alternatively, an indication that the recorded program file is available is uploaded 316 to the CDN centre node 150. The recorded program file may then be streamed directly from the CDN edge server 110.

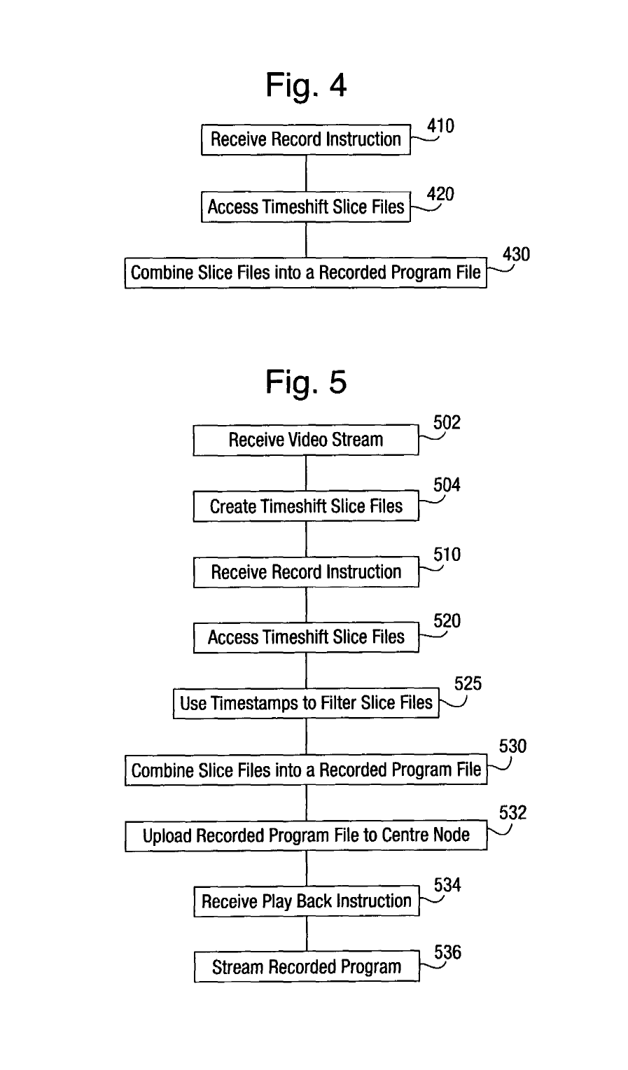

FIG. 4 illustrates the basic method of improved programme recording described herein. At 410 a recording instruction is received. At 420 the time shift slice files are retrieved then at 430 the retrieved time shift slice files are combined into a recorded programme file. Because the time shift slice files are retrieved within the edge server and combined to create the recorded program file, fewer network resources are required for creating the file. Further, the recorded program file may be made available directly from the edge server, reducing time taken to make the recording available to the user. Some further details of this method will be described with reference to FIG. 5.

FIG. 5 illustrates an alternative method of programme recording as described herein. At 502 a video stream is received. At 504 time shift slice files are created in order to provide time shift functionality to an at least one end-user equipment. At 510 a record instruction is received. The record instruction originates at a end-user equipment and may be received via a content management system 160. At 520 the time shift slice files are accessed and at 525 the timestamps of the slice files are used to filter them and to identify the time shift slice files corresponding to the portion of the video stream to be recorded. At 530 the relevant time shift slice files are combined into a recorded programme file. At this stage, an index and trick play index are generated to complete the recorded programme file.

At 532 the recorded programme file is uploaded to the centre node 150.

Alternatively, instead of uploading the recorded program file to the centre node at 532, an indication that the recorded program file is available may be uploaded centre node 150. The recorded program file may then be streamed directly from the CDN edge server 110.

At 534 a playback instruction is received from a terminal 100 and that 536 streaming of the recorded programme file to the terminal 100 is begun.

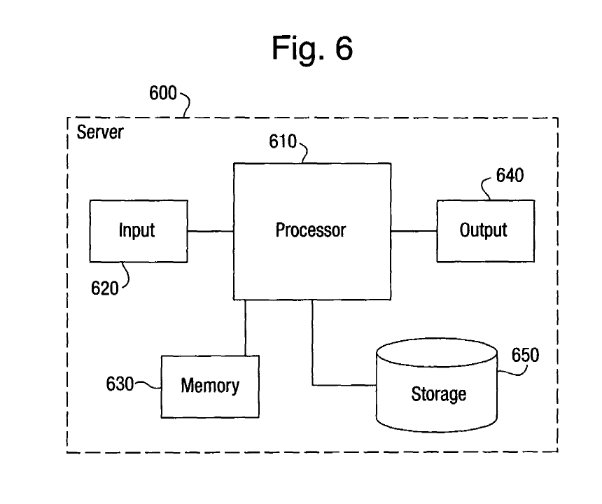

FIG. 6 illustrates an apparatus for performing the method described herein. A server 600 comprises a processor 610, an input 620, a memory 630, an output 640 and storage 650. The processor 610 is arranged to receive instructions which, when executed, causes the processor 610 to carry out the above described method. The instructions may be stored on the memory 630. Input 620 is arranged to receive programme streams via the content delivery network. Output 640 is arranged to deliver streamed content to user terminals 100. The storage 650 may further arranged to store time shift slice files and to hold recently created recorded programme files.

It will be apparent to the skilled person that the exact order and content of the actions carried out in the method described herein may be altered according to the requirements of a particular set of execution parameters. Accordingly, the order in which actions are described and/or claimed is not to be construed as a strict limitation on order in which actions are to be performed.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfill the functions of several units recited in the claims. Any reference signs in the claims shall not be construed so as to limit their scope

While examples have been given in the context of general media streaming, it should be noted that this encompasses specific examples such as HTTP Adaptive Streaming. The principles disclosed herein can be applied to any streaming system which uses time shift files. For example, this method and apparatus may be applied to Apple™ HTTP Live Streaming, and Microsoft™ Smooth Streaming.

1. A method of recording a program in a server, the method comprising:
receiving a record instruction to record a particular program;
accessing a plurality of time shift slice files associated with the particular program; and
combining the slice files into a recorded program file.

2. The method of claim 1, further comprising using timestamps of slice files to determine which are associated with the particular program.

3. The method of claim 1, further comprising receiving a video stream and creating a plurality of time shift slices of the video stream.

4. The method of claim 1, further comprising uploading the recorded program file to a center node.

5. The method of claim 1, further comprising:
receiving a playback instruction from a terminal; and
streaming the recorded program to the terminal in response to the playback instruction.

6. The method of claim 1, wherein the server receives a video stream which it:
outputs as a live stream;
uses to provide a time shift service; and
records for later streaming.

7. The method of claim 1, wherein the server comprises a network personal video recorder, PVR.

8. A server arranged to record a program, the server comprising:
an input arranged to receive a record instruction to record a particular program;
a memory arranged to store a plurality of time shift slice files associated with the particular program; and
a processor arranged to combine the slice files into a recorded program file.

9. The server of claim 8, wherein the processor is further arranged to use timestamps of slice files to determine which are associated with the particular program.

10. The server of claim 8, wherein the processor is further arranged to receive a video stream and create a plurality of time shift slices of the video stream.

11. The server of claim 8, further comprising an output for sending the recorded program file to a center node.

12. The server of claim 8, wherein the input is further arranged to receive a playback instruction from a terminal; and in response thereto the server streams the recorded program to the terminal via an output.

13. The server of claim 8, wherein the server is arranged to receive a video stream, which it:
outputs as a live stream;
uses to provide a time shift service; and
records for later streaming.

14. The server of claim 8, wherein the server comprises at least one of an edge server and a network personal video recorder, PVR.

15. A non-transitory computer-readable medium, carrying instructions, which, when executed by computer logic, causes said computer logic to carry out any of the method of claim 1.
